(19) United States
(12) Patent Application Publication
(10) Pub. No.: US 2021/0124016 A1
(43) Pub. Date: Apr. 29, 2021

(54) WIRELESS SYNCHRONIZATION OF FMCW RADAR DETECTORS AND TRANSMITTERS

(71) Applicant: SpotterRF LLC, Orem, UT (US)

(72) Inventor: Logan Carl Harris, Orem, UT (US)

(73) Assignee: SpotterRF LLC, Orem, UT (US)

(21) Appl. No.: 16/660,983

(22) Filed: Oct. 23, 2019

(51) Int. Cl. G01S 7/40; G01S 7/35; H04B 14/00

(52) U.S. Cl. CPC G01S 7/4056; G01S 7/4008; H04B 14/006; G01S 7/354; G01S 7/4021

(57) ABSTRACT

A method for wirelessly synchronizing a radar detector to a radar transmitter includes wirelessly receiving a first instance of a frequency-modulated continuous-wave (FMCW) radar signal directly emitted by the radar transmitter, determining a frequency slope change event in the FMCW radar signal using the first instance of the FMCW radar signal and temporally synchronizing the radar detector to the radar transmitter based on the frequency slope change event. Determining the frequency slope change event may include generating a frequency slope monitoring signal. In some embodiments, generating the frequency slope monitoring signal comprises mixing the first instance of the FMCW radar signal with a second instance of the FMCW radar signal. The second instance of the FMCW radar signal may be a reflected instance or a locally delayed instance of the first instance. A corresponding apparatus, computer readable medium and system are also disclosed herein.

### BACKGROUND OF THE INVENTION

### Field of the Invention

The subject matter disclosed herein relates to radar systems in general and, in particular, to frequency-modulated continuous wave (FMCW) radar systems.

### Description of the Related Art

The ability to spot and track targets is an important aspect of providing security for commercial buildings, public buildings, government facilities, power generation and water treatment plants, transportation hubs, border positions, and the like. As the need for surveillance increases, the potential for interference between radar units also increases.

As depicted in FIG. 1A, one solution to this issue is to place multiple radar detectors 110 for each radar transmitter 120 within a monitored environment 100. However, for successful operation of FMCW radar systems, each radar detector 110 must be synchronized to the radar transmitter 120 it is associated with. Historically, synchronization between physically separated radar detectors 110 and radar transmitters 120, such as those shown in FIG. 1A, has required that each radar detector 110 be electronically coupled to the corresponding radar transmitter via a coaxial cable or fiberoptic cable.

### SUMMARY OF THE INVENTION

The present invention has been developed in response to the present state of the art, and in particular, in response to the problems and needs in the art that have not yet been fully solved by currently available radar systems. Accordingly, the present invention has been developed to provide a method, apparatus, and computer readable medium for synchronizing radar detectors to radar transmitters that overcome shortcomings in the art.

For example, one embodiment of a method for wirelessly synchronizing a radar detector to a radar transmitter includes wirelessly receiving a first instance of a frequency-modulated continuous-wave (FMCW) radar signal directly emitted by the radar transmitter, determining a frequency slope change event in the FMCW radar signal using the first instance of the FMCW radar signal and temporally synchronizing the radar detector to the radar transmitter based on the frequency slope change event. Determining the frequency slope change event may include generating a frequency slope monitoring signal. In some embodiments, generating the frequency slope monitoring signal comprises mixing the first instance of the FMCW radar signal with a second instance of the FMCW radar signal. The second instance of the FMCW radar signal may be a reflected instance or a locally delayed instance of the first instance.

A corresponding apparatus and system are also disclosed herein. Furthermore, the methods described herein may be embodied as a non-transitory computer program product or computer readable medium comprising computer executable instructions that are configured to conduct the described methods.

It should be noted that references throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

These features and advantages will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1A is a schematic diagram illustrating one example of a monitored environment 100 in which at least one embodiment disclosed herein may be deployed;

FIG. 1B is a flowchart diagram depicting one example of a radar detector synchronization method in accordance with at least one embodiment disclosed herein;

FIG. 2 is a block diagram depicting one embodiment of a FMCW target tracking system in accordance with at least one embodiment disclosed herein;

FIG. 3 is a schematic block diagram depicting certain details of one particular embodiment of the radar detector shown in FIG. 2; and

FIG. 4 is a graphical diagram depicting one example of a frequency slope monitoring signal.

### DETAILED DESCRIPTION OF THE INVENTION

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

The embodiments disclosed herein recognize that synchronization of FMCW radar detectors and transmitters can occur by detecting changes in the frequency slope of a transmitted FMCW radar signal.

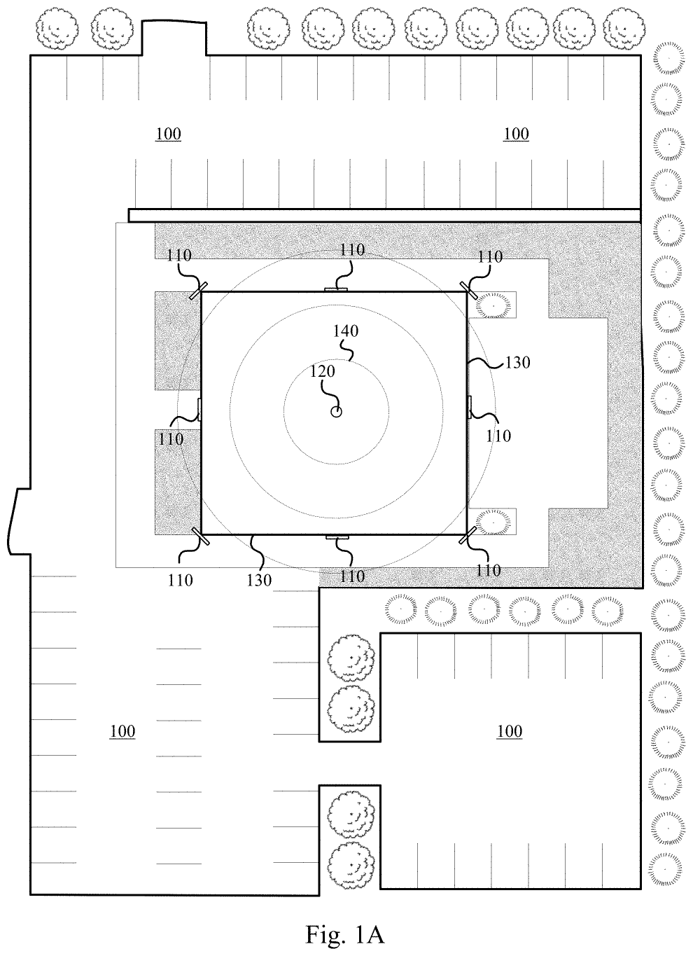

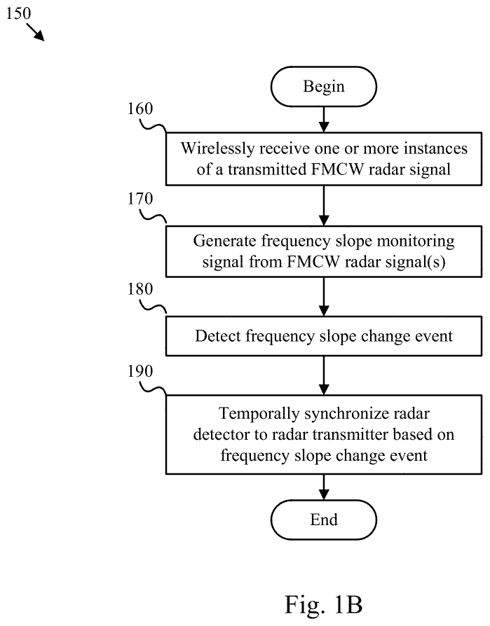

FIG. 1B is a flowchart diagram depicting one example of a radar detector synchronization method 150 in accordance with at least one embodiment disclosed herein. As depicted, the radar detector synchronization method 150 includes wirelessly receiving (160) one or more instances of a transmitted FMCW radar signal transmitted by a radar transmitter 120, generating (170) a frequency slope monitoring signal from the one or more instances, detecting (180) a frequency slope change event and temporally synchronizing (190) the radar detector 110 to the radar transmitter 120. The radar detector synchronization method 150 may be conducted by one or more radar detectors 110 in a monitored environment such as the monitored environment 100.

Wirelessly receiving (160) one or more instances of the transmitted FMCW radar signal may include using one or more antennas. In some embodiments, a synchronization antenna or antenna array is configured to receive the transmitted FMCW radar signal directly from the FMCW transmitter 120. In certain embodiments, the synchronization antenna or antenna array is a directional antenna that reduces reflected instances (i.e., images) of that transmitted FMCW radar signal. Examples of such as instances include instances that are reflected from environmental objects and potential targets. In some embodiments, one or more return signal antennas or antenna arrays are configured to receive reflected instances of the transmitted FMCW radar signal in order to track targets with a monitored environment such as the monitored environment 100.

Generating (170) a frequency slope monitoring signal from the one or more instances may be accomplished through a variety of means. In one embodiment, a mixer may mix a direct instance and a delayed instance of the FMCW radar signal and provide a baseband signal that contains frequency slope information. In another embodiment, a frequency-to-voltage converter converts the frequency of the transmitted FMCW radar signal to a voltage signal whose slope corresponds to the slope of the transmitted FMCW radar signal.

Detecting (180) a frequency slope change event may include monitoring the frequency slope monitoring signal and determining therefrom that a frequency slope change event has occurred in the FMCW radar signal.

Temporally synchronizing (190) the radar detector 110 to the radar transmitter 120 may include setting a clocked flip-flop or register that is clocked by a system clock for the radar detector. The system clock may be used by digital logic and/or processors that execute logic statements and/or instructions that control the radar detector 110.

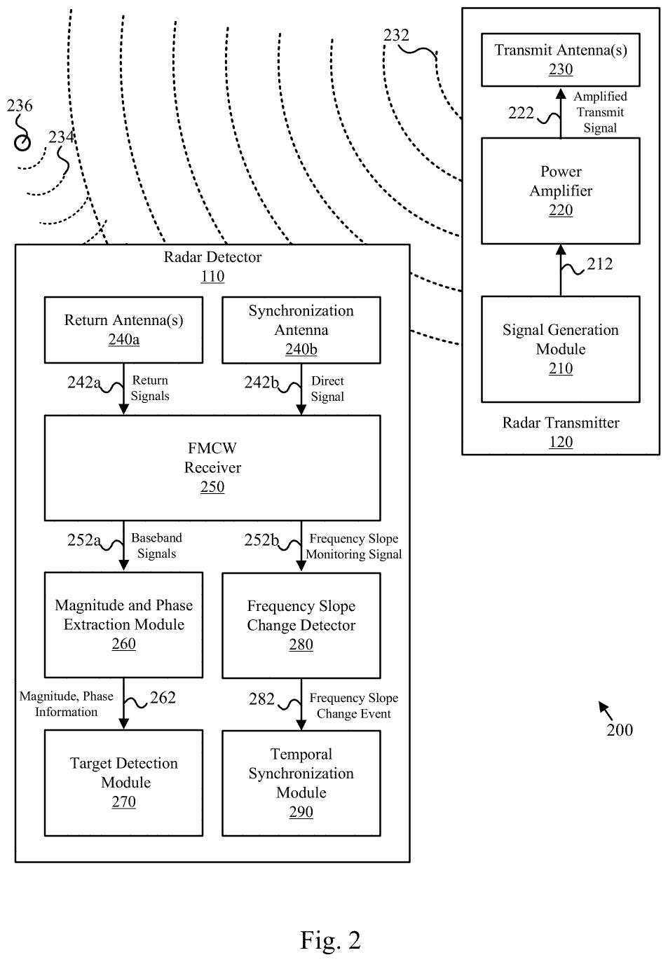

FIG. 2 is a block diagram depicting one embodiment of a FMCW target tracking system 200 in accordance with at least one embodiment disclosed herein, As depicted, the FMCW target tracking system 200 includes a radar transmitter 120 comprising a signal generation module 210, a power amplifier 220, and one or more transmit antennas 230. The depicted FMCW target tracking system 200 also includes a radar detector 110 comprising one or more return antennas 240a, a synchronization antenna 240b, an FMCW receiver 250, a magnitude and phase extraction module 260, a target detection and tracking module 270, a frequency slope change detector 280 and a temporal synchronization module 290. The target tracking system 200 enables detection and tracking of targets within a monitored environment such as the monitored environment 100.

The signal generation module 210 generates a transmit signal 212. The transmit signal 212 may be a continuous cyclic chirp signal whose rate of frequency change is substantially constant within the non-transitory (i.e., ramp up or ramp down) portions of a chirp cycle. In one embodiment, the rate of frequency change for the transmit signal 212 varies less than 20 milli-radians within the non-transitory portions of the chirp cycle over an operating period of 5 seconds. In some embodiments, the transmit signal is up-converted from a synthesized signal. In other embodiments, the transmit signal is directly synthesized. The frequency of the transmit signal may be selected to facilitate detection of ground or airborne targets. For example, in certain embodiments the operational frequency may be between 9.5 and 11 GHz to improve detection of airborne targets.

The power amplifier 220 amplifies the transmit signal 212 to provide the amplified transmit signal 222 to the transmit antenna(s) 230. The transmit antenna(s) 230 radiate an FMCW radar signal 232 corresponding to the amplified transmit signal 222. In one embodiment, the FMCW radar signal 232 is omni-directionally radiated in azimuth. Both reflected instances 234 and direct instances 232 of the radiated FMCW radar signal 232 may reach the radar detectors 110.

The return antennas 240a receive electromagnetic energy reflected by elements in the surrounding environment such as a target 236 and provide return (i.e., reflected) signals 242a. [Note: although the conventional phrase ‘return signal’ is used herein, the referenced return signal originates with the radar transmitter 120 and not the radar detectors 110.] The FMCW receiver 250 down-converts each return signal 242a to provide a corresponding baseband signal 252a. The magnitude and phase extraction module 260 extracts magnitude and phase information from each baseband signal 252a to provide magnitude and phase information 262.

The depicted FMCW receiver 250 receives a direct signal 242b provided by a synchronization antenna 240b. The synchronization antenna 240b is preferably (but not necessarily) configured to minimize reflected instances 234 of the FMCW radar signal 232 emitted by the radar transmitter 120. The direct signal 242b may be used by the FMCW receiver 250 to produce a frequency slope monitoring signal 252b. The direct signal 242b may also be used by the FMCW receiver 250 to facilitate down-conversion of the return signals 242a and produce the baseband signals 252a.

The frequency slope change detector 280 may detect frequency slope change events for the FMCW radar signal 232 by monitoring the frequency slope monitoring signal 252b. In response to detection, the frequency slope change detector 280 may activate a frequency slope change event semaphore 282. The temporal synchronization module 290 may detect activation of the frequency slope change event semaphore 282 and synchronize the modules of the radar detector 110 (i.e., to the radar transmitter 120) in response to that activation. For example, sampling clocks such as a baseband signal sampling clock associated with the magnitude and phase extraction module 260 may be reset or adjusted by the temporal synchronization module 290 so that radar data is sampled consistently across FMCW chirp cycles.

The target detection and tracking module 270 processes the magnitude and phase information 262 provided by module 260 to provide target location and tracking information 272 and antenna control information 274 that enables the radar detector 110 to focus on one or more targets 236. The target location and tracking information 292 may be presented to a user and also used to update the antenna control information 274 and focus a return antenna or antenna array on the target 236. For example, the target location and tracking information 292 may be overlaid on a map along with a (highlighted) movement path for the target 236.

In some embodiments, the target detection and tracking module 270 includes a behavior filter (not shown) that observes the movements of potential targets (e.g., micro-doppler movements) and other characteristics of the return signal and determines a category type for the potential target. For example, the behavior filter may use potential target information such as speed, heading, heading pattern and duration, vibration patterns, altitude, and radar cross section to determine if the potential target is an aircraft, a land vehicle, a pedestrian, an animal (e.g., a bird or dog) or stationary object such as a treetop. The target detection and tracking module 270 may also use the foregoing potential target information or the like to further classify the target (e.g., vehicle make and model). The potential target information and classification information may be included in the target location and tracking information 272.

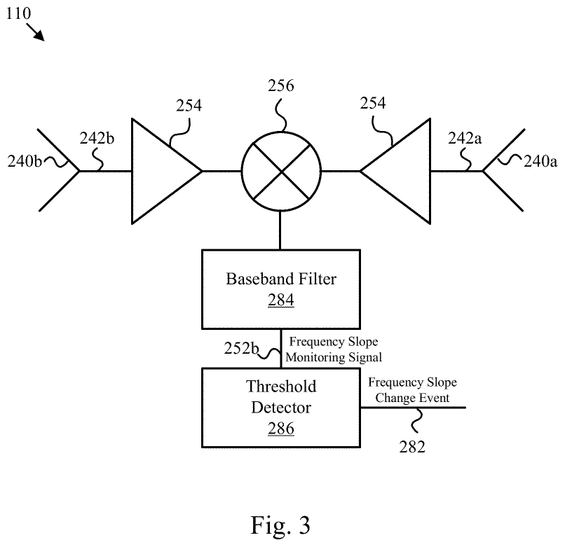

FIG. 3 is a schematic block diagram depicting certain details of one particular embodiment of the radar detector 110 shown in FIG. 2. In the depicted embodiment, the synchronization antenna 240b and one of the return signal antennas 240a provide a direct instance 242b and a reflected instance 242a, respectively, of the FMCW radar signal transmitted by the radar transmitter 120. The direct instance 242b and the reflected instance 242a are amplified by low noise amplifiers 254 and fed into a mixer 256. The mixed signal is fed into a baseband filter 284 to produce the frequency slope monitoring signal 252b. In the depicted embodiment, the frequency slope monitoring signal 252b is fed into a threshold detector which, when triggered, activates the frequency slope change event semaphore 282.

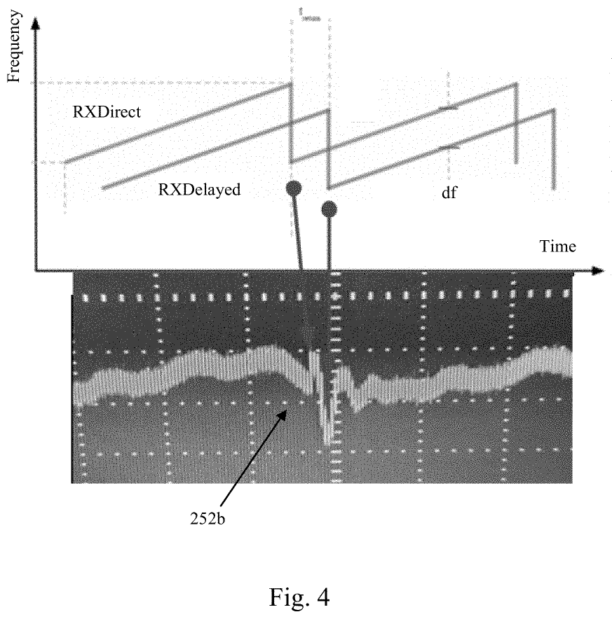

One of skill in the art will appreciate that the reflected instance will lag behind the direct instance according the difference in propagation distances for those two signals. In another embodiment, a delay circuit or delay line (not shown) is applied to the direct instance 242b to produce a locally delayed instance (not shown). The locally delayed instance may be fed into the mixer instead of the reflected instance. As shown in FIG. 4, the lag between the two signals results in spikes in the frequency slope monitoring signal 252b when the frequencies of the two signals cross each other. In the depicted example, the frequencies of the two signals cross each other during the retrace portion of the FMCW ramp cycle. However, frequency crossing events also occur for triangular FMCW patterns when the signal changes from a positive frequency slope to a negative frequency slope and vice versa. The threshold detector 286 can detect the spikes that occur with frequency crossings and activate the frequency slope change event semaphore 282 and thereby signal the temporal synchronization module 290. In one embodiment, the threshold detector is embodied as an analog-to-digital converter and threshold detection software that executes on a processor for the radar detector 110.

Returning to FIGS. 2 and 3, one of skill in the art will appreciate that in some embodiments, the frequency slope monitoring signal 252b may be the same as one of the baseband signals 252a.

One of skill in the art will also appreciate that means other than those depicted in the drawings may be used to monitor the frequency slope of the direct instance of the FMCW radar signal. For example, analysis of the direct instance of the FMCW radar signal may be possible in certain embodiments using a high-speed analog-to-digital converter, a frequency-to-voltage converter or a phase-locked loop coupled to a digital counter.

Returning to FIG. 1A, one of skill in the art will appreciate that the synchronization means and methods presented herein enable physical and electrical separation of the radar detectors 110 from each other and from the radar transmitter 120. For example, the radar detectors 110 may be displaced from the radar transmitter 130 by meters or even kilometers without requiring an electrical or optical connection or transmission link between the radar detectors 110 and the radar transmitter 120. However, in some embodiments it may be advantageous to mount at least one of the radar detectors 110 and the radar transmitter 120 on a common physical structure such as a building or a pole.

In the depicted arrangement, eight radar detectors 110 are disposed around the perimeter of a building 130. Furthermore, each depicted radar detector 110 faces outward away from the building toward the propagation direction of the radar signal 140 emitted by the radar transmitter 120. Facing outward enables a return antenna 240a (not shown) disposed on the front of each radar detector 110 to receive reflections of the radar signal 140 reflected from objects in the monitored environment 100. Furthermore, a synchronization antenna 240b (not shown) disposed on the backside of radar detector 110 and oriented toward the radar transmitter 120 enables direct reception of the radar signal 140 and synchronization of each radar detector 110 to the radar transmitter 120.

It should be noted that many of the functional units described in this specification have been labeled as modules. Others are assumed to be modules. Modules may be embodied as hardware devices and/or digital processing units with executable instructions such as software or firmware. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented as a processor configured with executable software. An identified module may include executable code that, for instance, comprises one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, the executable code of a module may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices.

Reference to a computer program product or computer-readable medium may take any non-transitory form capable of causing execution of a program of machine-readable instructions on a digital processing apparatus. For example, a computer-readable medium may be embodied by a compact disk, digital-video disk, a magnetic tape, a Bernoulli drive, a magnetic disk, a punch card, flash memory, integrated circuits, or other digital processing apparatus memory device.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method for wirelessly synchronizing a radar detector to a radar transmitter, the method comprising:
wirelessly receiving a first instance of a frequency-modulated continuous-wave (FMCW) radar signal directly emitted by the radar transmitter;
determining a frequency slope change event in the FMCW radar signal using the first instance of the FMCW radar signal; and
temporally synchronizing the radar detector to the radar transmitter based on the frequency slope change event.

2. The method of claim 1, wherein determining the frequency slope change event includes generating a frequency slope monitoring signal.

3. The method of claim 2, wherein generating the frequency slope monitoring signal comprises mixing the first instance of the FMCW radar signal with a second instance of the FMCW radar signal.

4. The method of claim 3, wherein the second instance of the FMCW radar signal is a reflected instance.

5. The method of claim 3, wherein the second instance of the FMCW radar signal is a locally delayed instance.

6. The method of claim 1, wherein determining the frequency slope change event includes tracking the frequency of the first instance of the FMCW radar signal.

7. The method of claim 1, wherein the frequency slope change event corresponds to a frequency discontinuity or a frequency slope change in the FMCW radar signal.

8. The method of claim 1, wherein the radar detector is displaced from the radar transmitter by at least 0.1 meters.

9. The method of claim 1, wherein the radar detector is displaced from the radar transmitter by at least 20 meters.

10. The method of claim 1, wherein the radar detector and radar transmitter are mounted on a common physical structure.

11. The method of claim 1, wherein the radar detector is not electronically or optically connected to the radar transmitter.

12. An apparatus for wirelessly coupling and synchronizing a radar detector to a radar transmitter, the apparatus comprising:
an FMCW receiver configured to wirelessly receive a first instance of a frequency-modulated continuous-wave (FMCW) radar signal directly emitted from the radar transmitter;
a frequency slope change detector configured to determine, using the first instance of the FMCW radar signal, a frequency slope change event in the FMCW radar signal; and
a temporal synchronization module configured to temporally synchronize the radar detector to the radar transmitter based on the frequency slope change event.

13. The apparatus of claim 12, wherein the FMCW receiver comprises a mixer configured to mix the first instance of the FMCW radar signal with a second instance of the FMCW radar signal and generate a baseband signal.

14. The apparatus of claim 13, wherein the second instance of the FMCW radar signal is a reflected instance or a locally delayed instance.

15. The apparatus of claim 12, wherein the frequency slope change event corresponds to a frequency discontinuity or a frequency slope change in the FMCW radar signal.

16. The apparatus of claim 12, further comprising one or more antennas.

17. A computer readable medium that is not a transitory signal per se, the computer readable medium comprising executable codes for executing a method for wirelessly synchronizing a radar detector to a radar transmitter, the method comprising:
wirelessly receiving a first instance of a frequency-modulated continuous-wave (FMCW) radar signal directly emitted by the radar transmitter;
determining a frequency slope change event in the FMCW radar signal using the first instance of the FMCW radar signal; and
temporally synchronizing the radar detector to the radar transmitter based on the frequency slope change event.

18. The computer readable medium of claim 17, wherein determining the frequency slope change event includes generating a frequency slope monitoring signal.

19. The computer readable medium of claim 18, wherein generating the frequency slope monitoring signal comprises mixing the first instance of the FMCW radar signal with a second instance of the FMCW radar signal.

20. The computer readable medium of claim 19, wherein the second instance of the FMCW radar signal is a reflected instance or a locally delayed instance.
